(19) United States
(12) Patent Application Publication
(10) Pub. No.: US 2026/0340185 A1
(43) Pub. Date: Oct. 29, 2026

(54) SYSTEMS AND METHODS FOR PROVIDING NEUROMORPHIC PRIVACY LEARNING AND A DYNAMIC PRIVACY PERIMETER

(71) Applicant: Verizon Patent and Licensing Inc., Basking Ridge, NJ (US)

(72) Inventors: Raghuram PARVATANENI, Frisco, TX (US); Parry Cornell BOOKER, Sunnyvale, TX (US); Medha JOSHI, Santa Clara, CA (US); Mahesh CHAPALAMADUGU, Plano, TX (US)

(73) Assignee: Verizon Patent and Licensing Inc., Basking Ridge, NJ (US)

(21) Appl. No.: 19/187,465

(22) Filed: Apr. 23, 2025

(51) Int. Cl. G06F 21/62; G06F 21/60; G06F 21/78; H04L 9/00; H04L 9/32; H04L 9/40

(52) U.S. Cl. CPC G06F 21/6254; G06F 21/60; G06F 21/62; G06F 21/6245; G06F 21/78; H04L 9/00; H04L 9/32; H04L 63/1441

(57) ABSTRACT

A device may receive a request to access data, and may convert the request into one or more neural signals. The device may process the one or more neural signals, with a plurality of privacy neurons and a plurality of privacy synapses, to generate aggregated outputs, and may determine whether the aggregated outputs are associated with a privacy threat, ephemeral usage data, or stable pattern data. The device may perform an action for the request based on determining whether the aggregated outputs are associated with the privacy threat, the ephemeral usage data, or the stable pattern data.

### BACKGROUND

In modern telecommunications and related data services, network application programming interfaces (APIs) have been introduced that expose valuable and sensitive data to various applications and entities.

### BRIEF DESCRIPTION OF THE DRAWINGS

FIGS. 1A-1I are diagrams of an example associated with providing neuromorphic privacy learning and a dynamic privacy perimeter.

FIG. 2 is a diagram of an example environment in which systems and/or methods described herein may be implemented.

FIG. 3 is a diagram of example components of one or more devices of FIG. 2.

FIG. 4 is a flowchart of an example process for providing neuromorphic privacy learning and a dynamic privacy perimeter.

### DETAILED DESCRIPTION OF EXAMPLE EMBODIMENTS

The following detailed description of example implementations refers to the accompanying drawings. The same reference numbers in different drawings may identify the same or similar elements.

APIs may provide information ranging from signal strength to anti-fraud indicators like subscriber identity module (SIM) swap data, and have become crucial for applications to adjust behavior according to real-time network conditions. Such services require increased integration of sensitive user and enterprise data. Traditional security gateways and rule-based systems, however, are largely static and fail to adapt to the continuously evolving nature of cyber threats. The traditional systems are often limited by predefined access controls and privacy policies that do not account for dynamic context of requests or behavior of requestors.

Moreover, the static privacy requirements assigned to different entities accessing APIs do not reflect changing trust levels or risk factors associated with each request. Current systems lack the capability to reassess trust in real-time, dynamically adjust data exposure, and incorporate advanced data protection mechanisms seamlessly throughout a data flow. Consequently, the current systems are susceptible to sophisticated attacks that can circumvent static defenses, leading to potential privacy breaches and unauthorized data access. Thus, current techniques for handling sensitive data consume computing resources (e.g., processing resources, memory resources, communication resources, and/or the like), networking resources, and/or other resources associated with failing to adapt to changing security threats over time, failing to adjust to changing trust levels or risk factors associated with each data request, handling privacy breaches caused by failing to adapt to changing security threats, trust levels, or risk factors, handling unauthorized data access caused by failing to adapt to changing security threats, trust levels, or risk factors, and/or the like.

Some implementations described herein provide a security system that provides neuromorphic privacy learning and a dynamic privacy perimeter. For example, the security system may receive a request to access data, and may convert the request into one or more neural signals. The security system may process the one or more neural signals, with a plurality of privacy neurons and a plurality of privacy synapses, to generate aggregated outputs, and may determine whether the aggregated outputs are associated with a privacy threat, ephemeral usage data, or stable pattern data. The security system may perform an action for the request based on determining whether the aggregated outputs are associated with the privacy threat, the ephemeral usage data, or the stable pattern data. Alternatively, or additionally, the security system may receive, from a user device, another request to access other data, and may determine a real-time risk associated with the other request. The security system may calculate a trust score based on the real-time risk, and may determine whether the trust score satisfies a first threshold. The security system may prevent access of the user device to the other data based on the trust score failing to satisfy the first threshold. The security system may determine whether the trust score satisfies a second threshold based on determining that the trust score satisfies the first threshold, may obscure the other data to generate obscured other data based on the trust score failing to satisfy the second threshold, and may provide the obscured other data to the user device. The security system may provide the other data to the user device based on the trust score satisfying the second threshold.

In this way, the security system provides neuromorphic privacy learning and a dynamic privacy perimeter. For example, the security system replaces static and inflexible security measures of current systems with a neuromorphic approach that dynamically assesses and responds to privacy risks in real-time. The neuromorphic approach may enable the security system to prevent the need for extensive rule-based processing and manual updates in response to new security threats. In addition, the security system may provide for efficient memory usage by separating specialized neurons and synapses for different privacy tasks, thus reducing redundant data processing. The security system may dynamically modulate data flow and decision weighting, which may enhance the security framework, streamline data exchanges, and minimize unnecessary data transmissions. Thus, the security system may conserve computing resources, networking resources, and/or other resources that would have otherwise been consumed by failing to adapt to changing security threats over time, failing to adjust to changing trust levels or risk factors associated with each data request, handling privacy breaches caused by failing to adapt to changing security threats, trust levels, or risk factors, handling unauthorized data access caused by failing to adapt to changing security threats, trust levels, or risk factors, and/or the like.

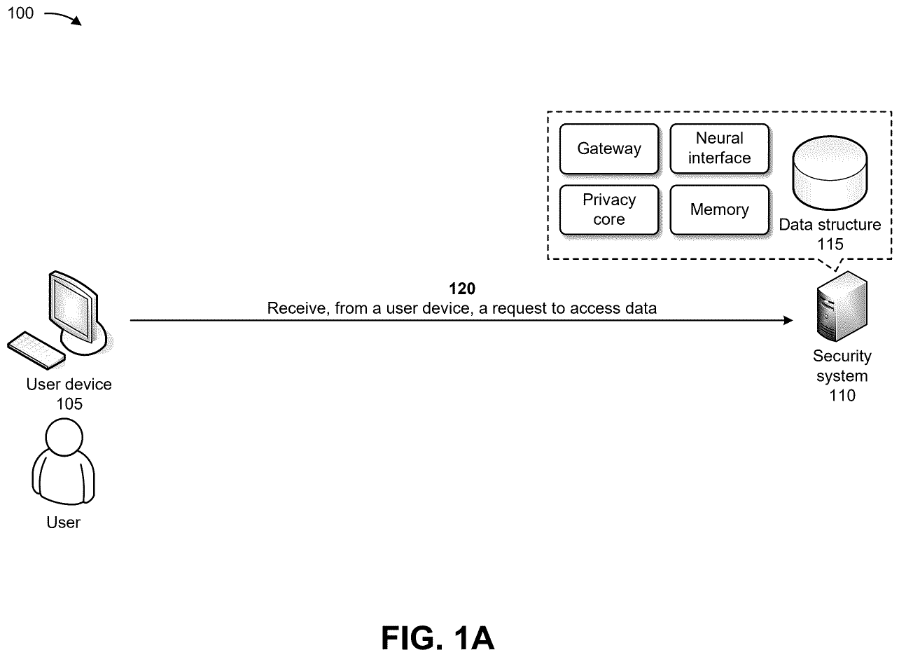

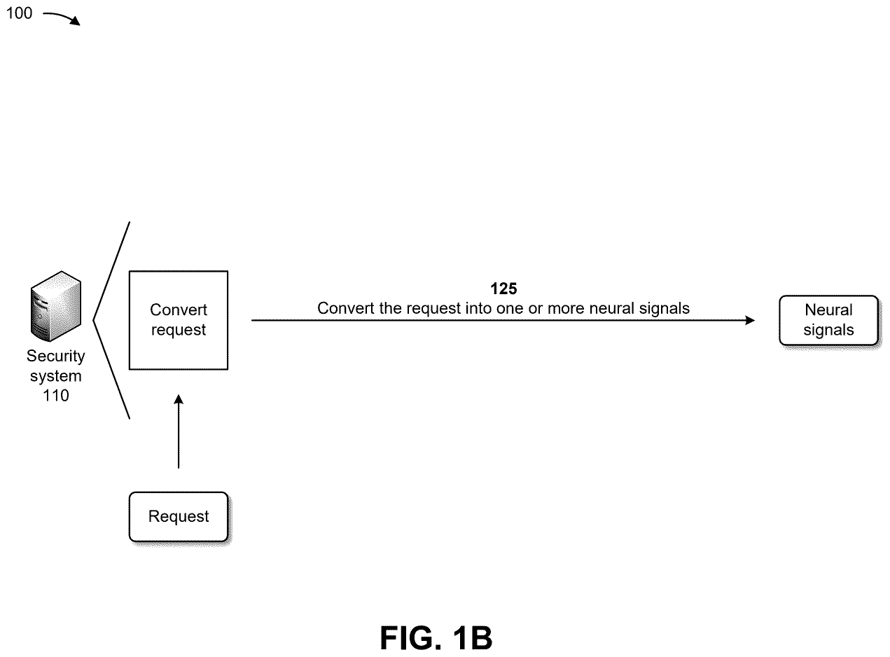

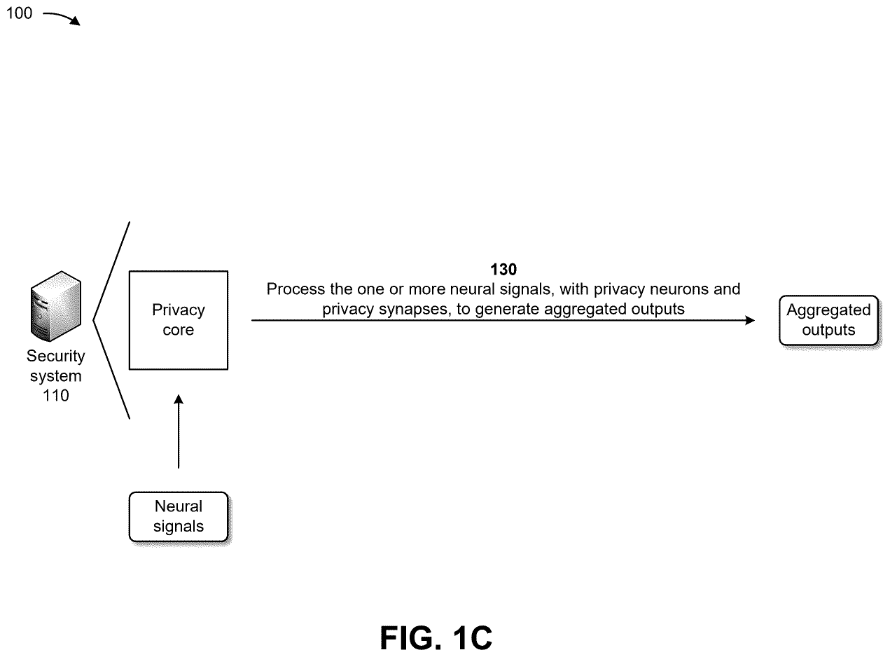

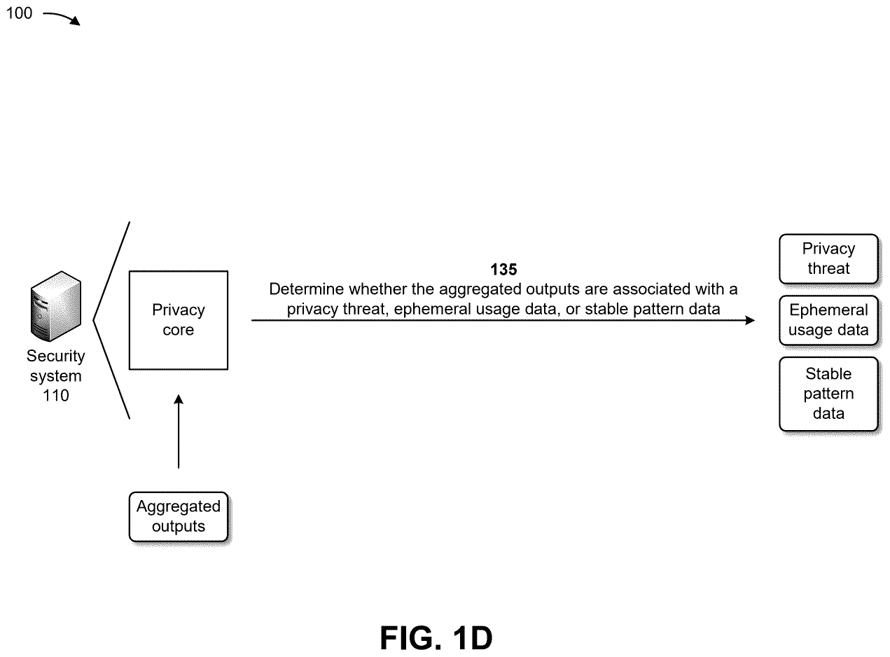

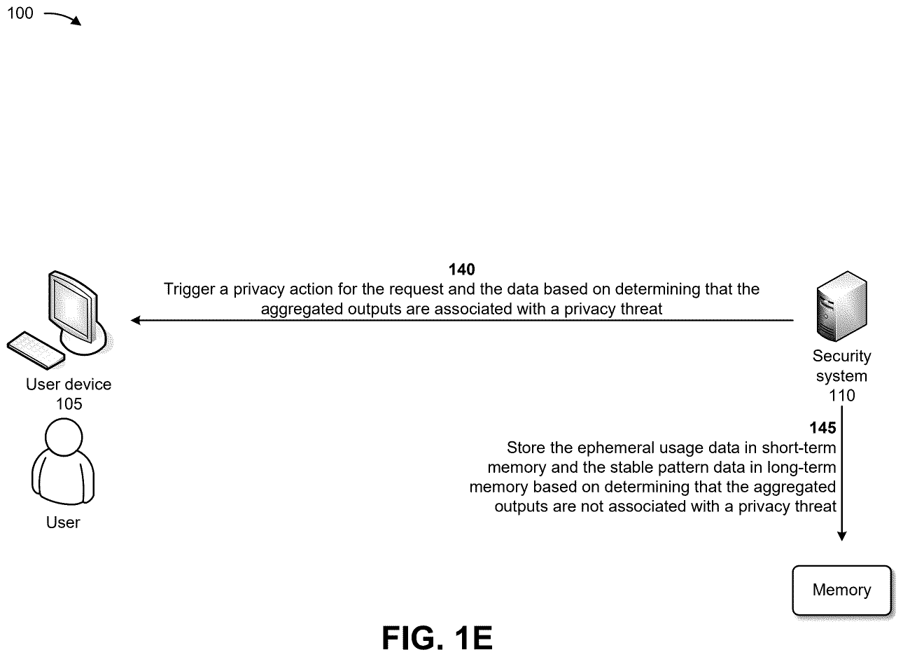

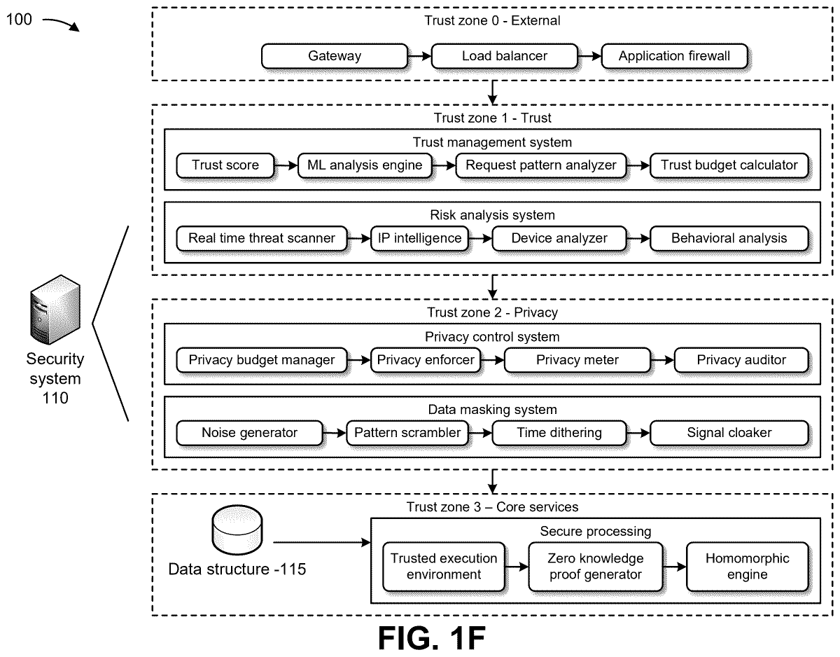

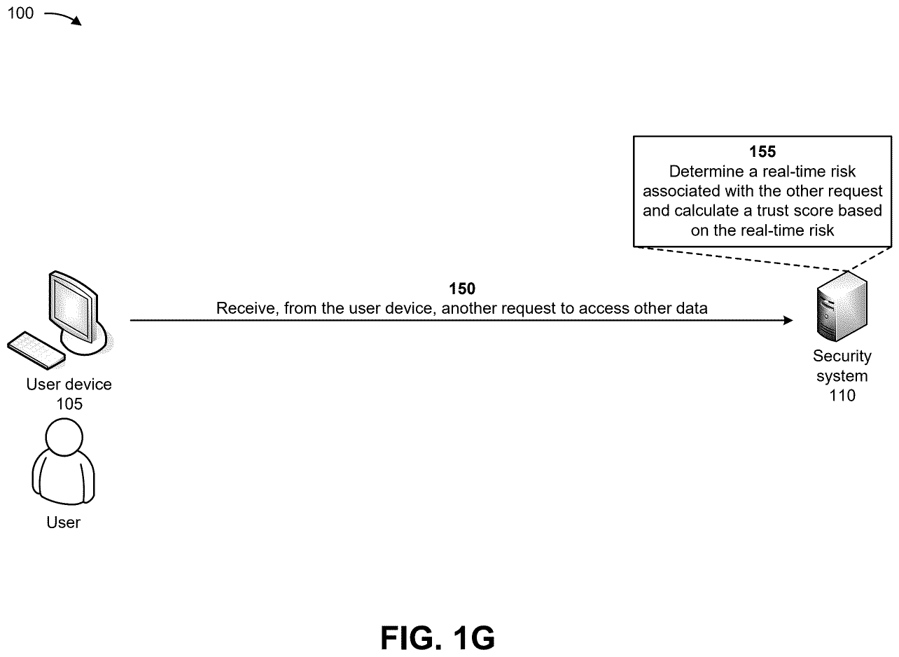

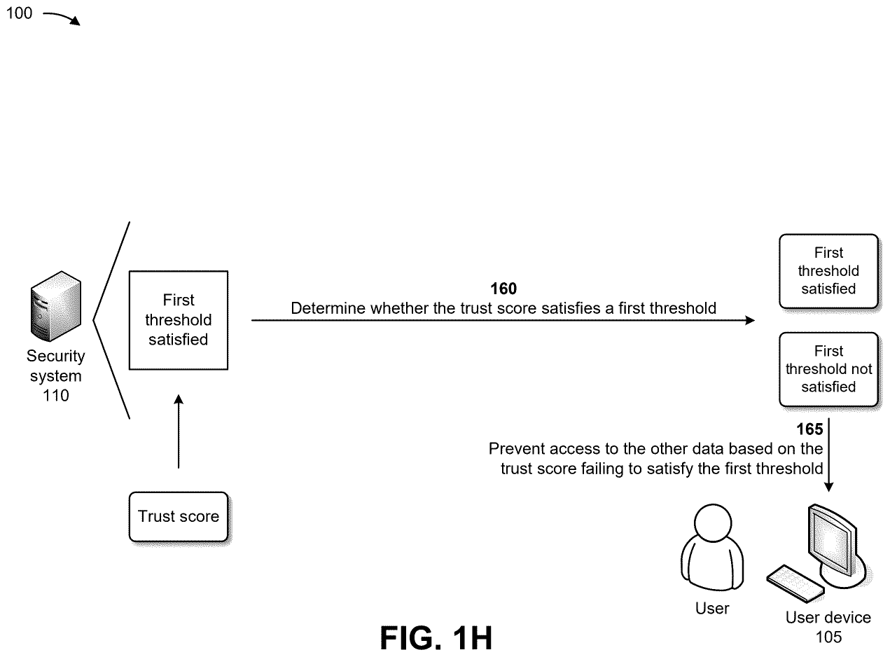

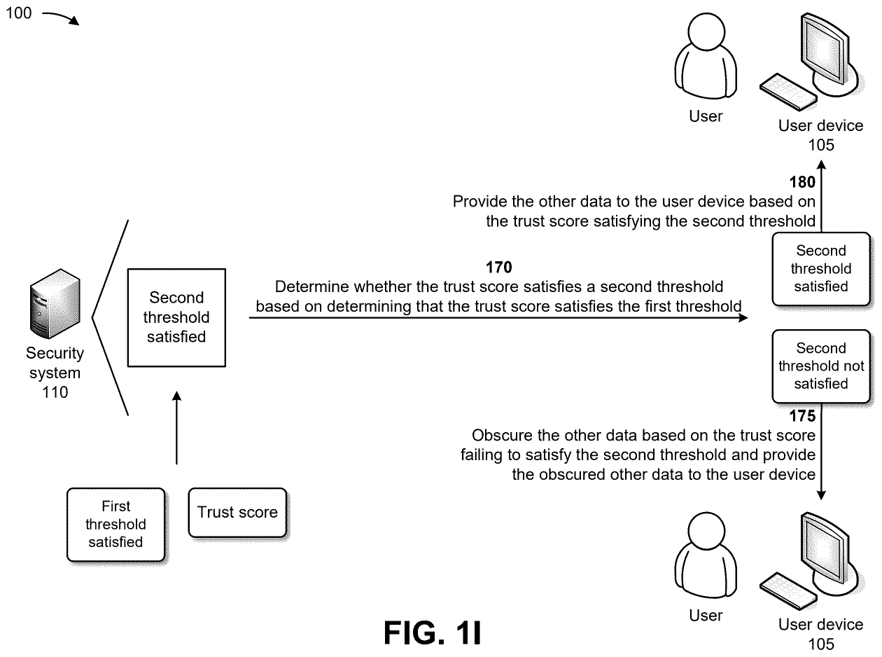

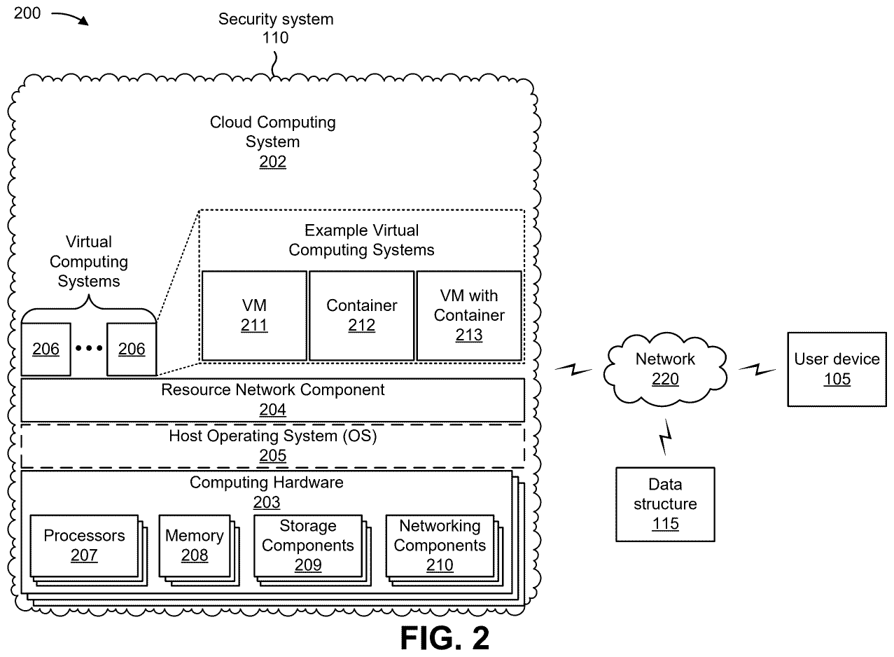

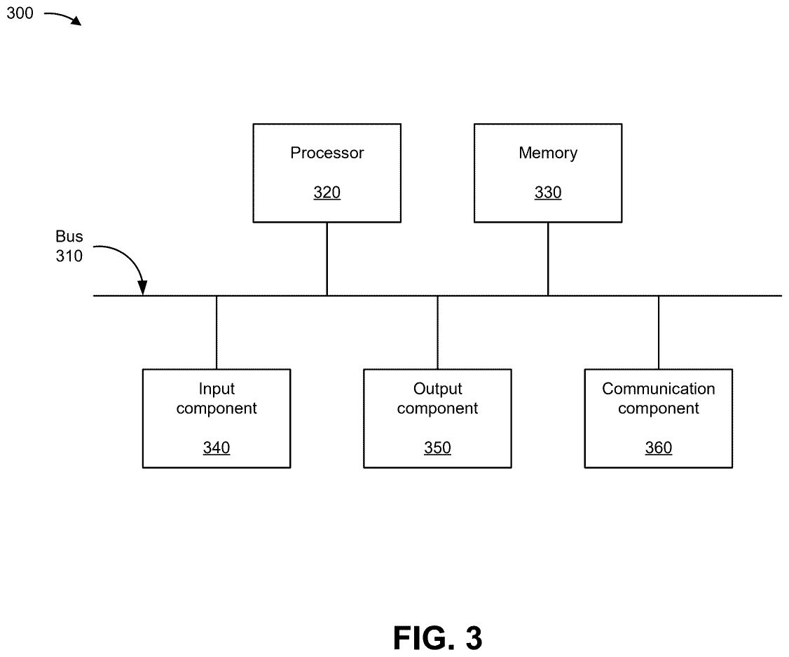

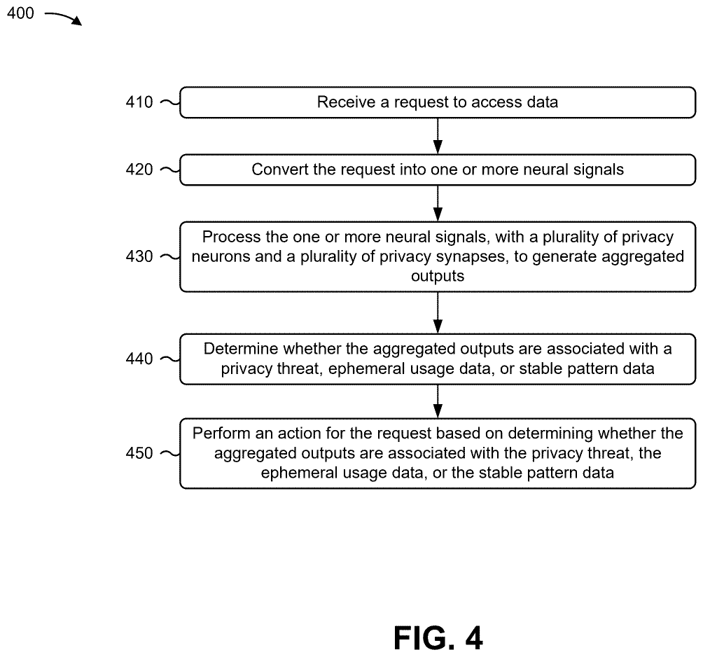

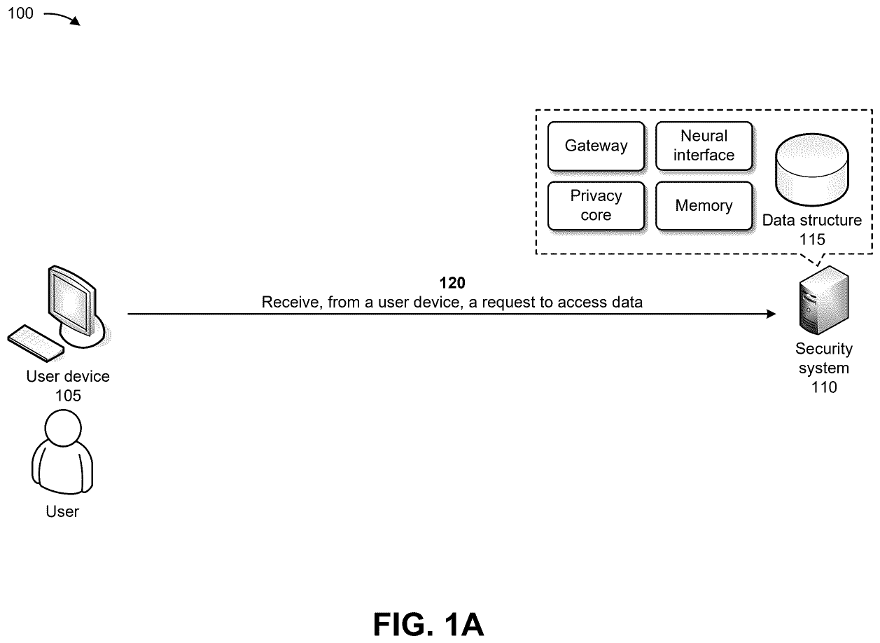

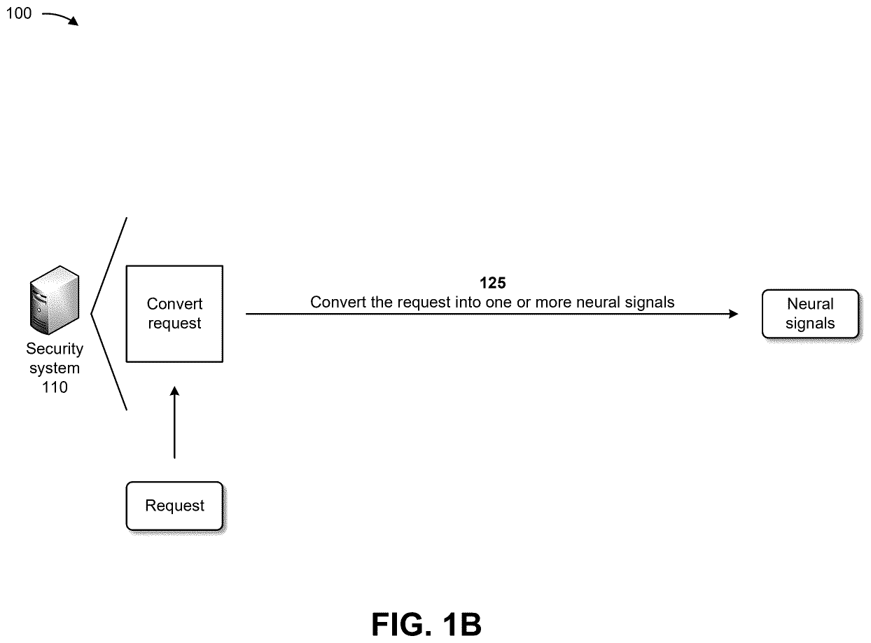

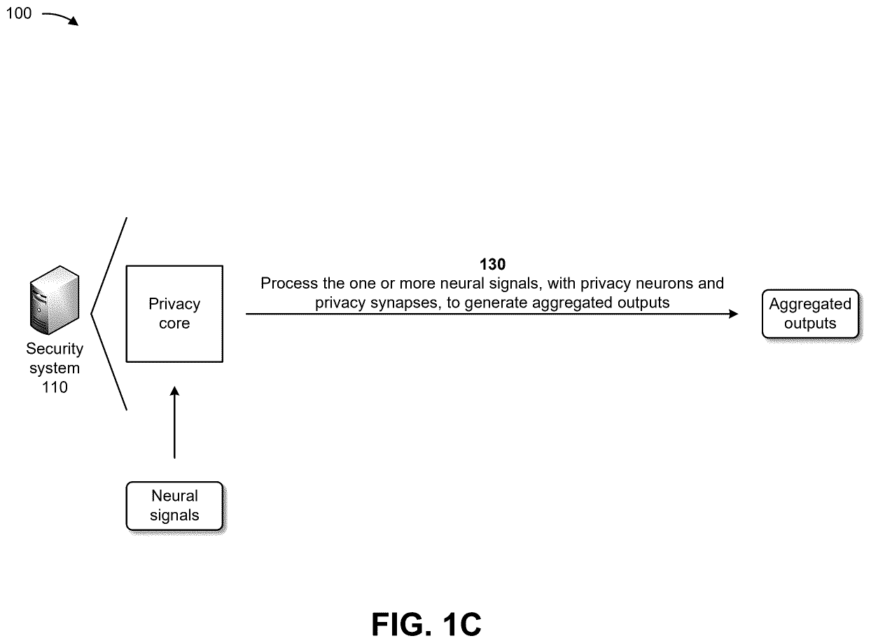

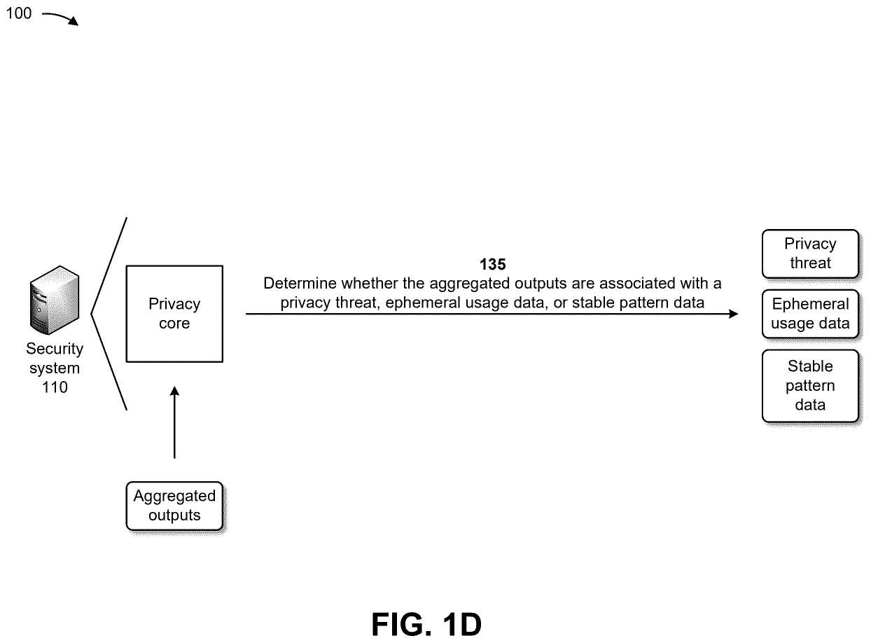

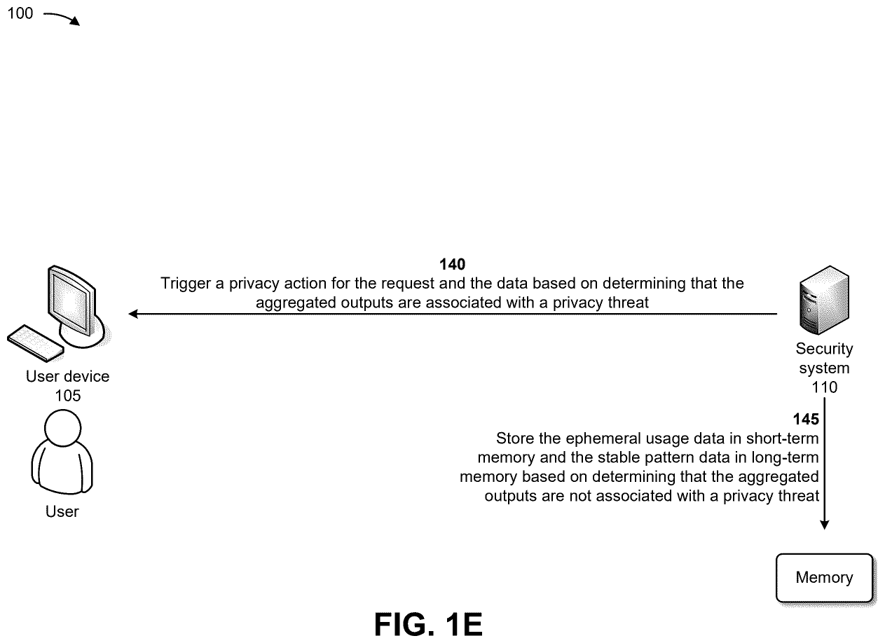

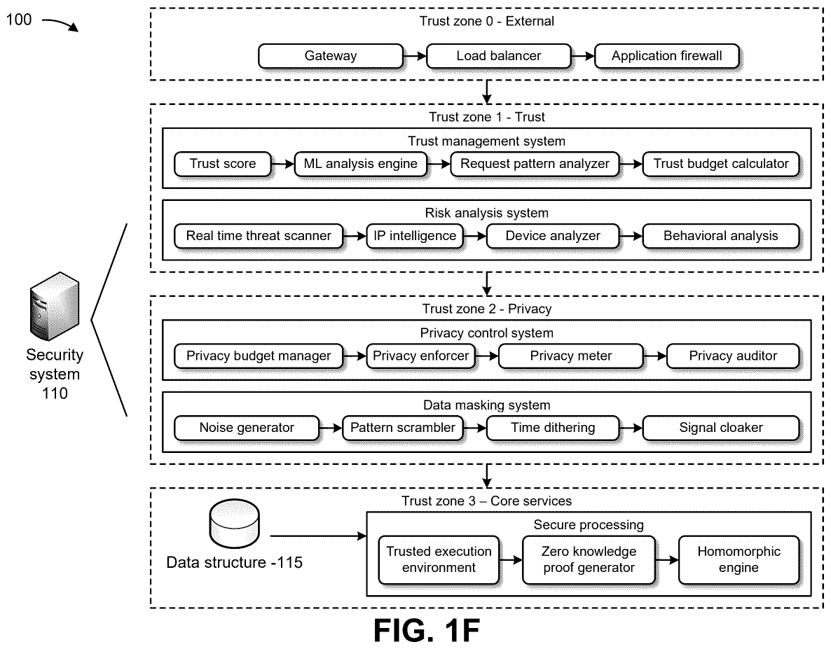

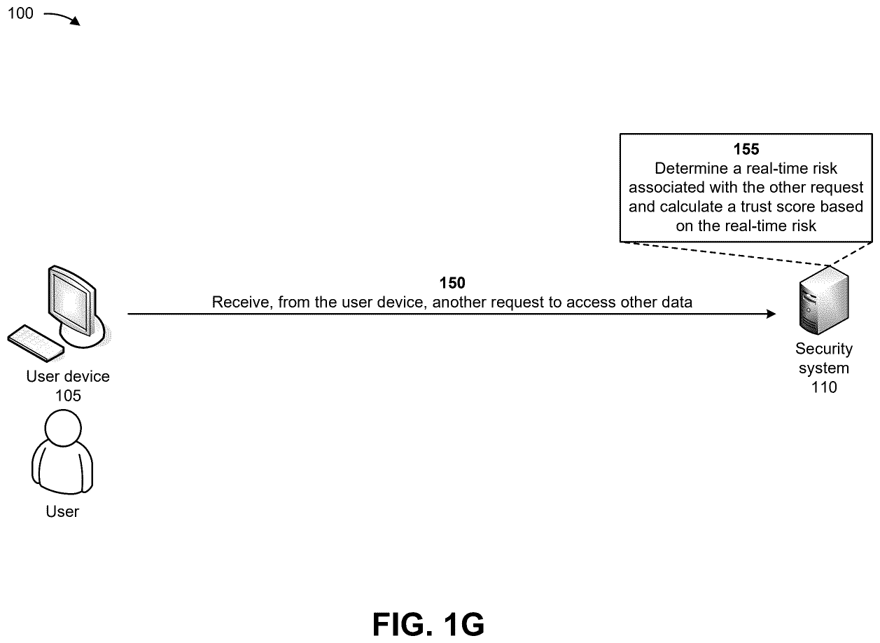

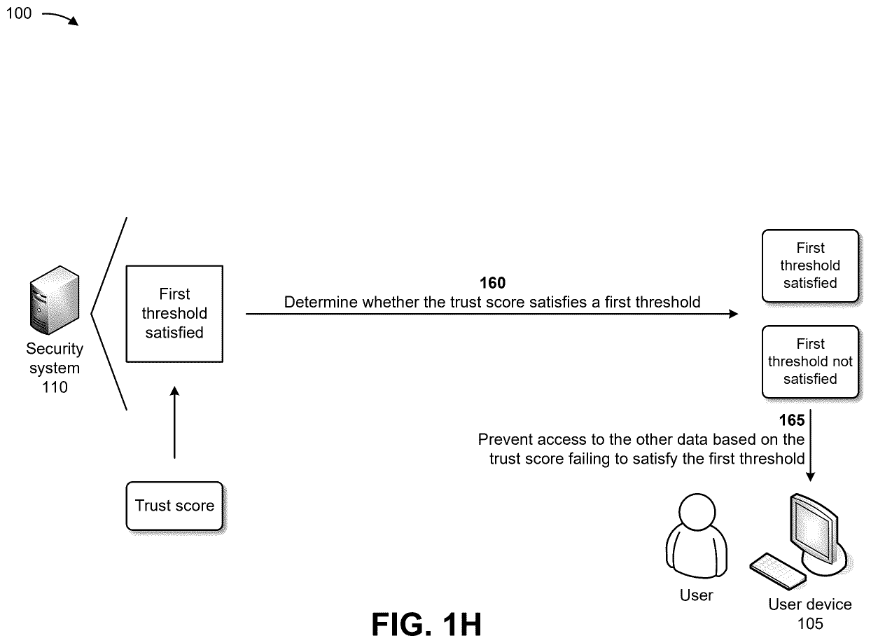

FIGS. 1A-1I are diagrams of an example 100 associated with providing neuromorphic privacy learning and a dynamic privacy perimeter. As shown in FIGS. 1A-1I, the example 100 includes a user device 105 associated with a user, a security system 110, and a data structure 115. The user may utilize the user device 105 to interact with the security system 110 and/or the data structure 115. The security system 110 may include a system that provides neuromorphic privacy learning and a dynamic privacy perimeter. The data structure 115 may include a database, a table, a list, and/or the like that stores information. Further details of the user device 105, the security system 110, and the data structure 115 are provided elsewhere herein. Although implementations described herein depict a single user device 105 and a single data structure 115, in some implementations, the security system 110 may be associated with multiple user devices 105 and/or multiple data structures 115.

In some implementations, security system 110 may include a privacy-focused neural network with specialized privacy neurons, privacy synapses, a multi-tiered memory approach, and a neural interface. The privacy neurons may be dedicated to analyzing patterns, threats, and trust specifically for privacy-related decisions. The privacy synapses may include adaptive connections that strengthen or weaken based on the learned experiences of the security system 110, and that control how data flows across the neural network. The multi-tiered memory may include a short-term memory and a long-term memory that is modeled after biological systems. The security system 110 may store ephemeral events in the short-term memory for immediate decisions and may store stable patterns in the long-term memory for ongoing adaptation. The neural interface may convert incoming requests (e.g., API requests or signals) into neural signals that a neuromorphic core processes to produce privacy actions (e.g., data masking, threat blocking, trust adjustments, and/or the like). In some implementations, the security system 110 may perform spike-based computations on specialized hardware (e.g., spiking neural network (SNN) chips or analog/digital hybrid neuromorphic chips).

As shown in FIG. 1A, the security system 110 may include a gateway, a neural interface, a neuromorphic privacy core, a memory, and the data structure 115. The gateway may include a network device (e.g., a router, a gateway, a switch, a firewall, a hub, a bridge, a reverse proxy), a server (e.g., a proxy server, a cloud server, or a data center server), a load balancer, and/or a similar device. The gateway may receive data requests from users and may determine whether the data requests and/or data usage are permitted. In some implementations, the gateway may receive data queries (e.g., via an application programming interface (API)) from users and may determine whether the data queries and/or data usage are permitted.

The neural interface may convert incoming requests (e.g., API requests or signals) into neural signals that a neuromorphic privacy core processes to produce privacy actions (e.g., data masking, threat blocking, trust adjustments, and/or the like). The neural interface may translate discrete, text-based or numeric-based queries into a spike-based representation or an analog neural signal that the neuromorphic core understands. The security system 110 may integrate seamlessly with traditional APIs, thereby maintaining backward compatibility with existing web services and RESTful APIs. As part of this integration, the security system 110 is capable of parsing incoming API queries. For example, upon receiving an API call such as a POST request with JavaScript Object Notation (JSON) content, the security system 110 may parse the JSON to extract key fields like a device identifier, a location zone, and a time period. These fields may be mapped to corresponding numeric or categorical codes, followed by their conversion into spiking patterns or analog neural signals through the neural interface. These signals may be processed by the neuromorphic privacy core, ensuring that the security system 110 can handle and respond to traditional API requests with enhanced privacy and security measures.

The neuromorphic privacy core may include spiking neurons that handle data in event-based ways, and that fire spikes to represent changes in input. The neuromorphic privacy core may include a privacy learning unit, an adaptation learning unit, and a threat learning unit. The privacy learning unit may identify repeated privacy patterns (e.g., consistent requests for certain data that might lead to overexposure). The adaptation learning unit may adjust internal neural connections or weightings in response to changing usage patterns or newly discovered threats. The threat learning unit may monitor suspicious or malicious behaviors, and may train the neural network to respond faster to such behaviors in the future. The neuromorphic privacy core may include privacy neurons, such as a pattern neuron, a threat neuron, and a trust neuron. The pattern neuron may recognize usage patterns (e.g., frequent queries from the same network address) that could raise or lower suspicion. The threat neuron may identify potential security incidents or anomalies. The trust neuron may provide a dynamic measure of the trust of the security system 110 in a request, and may be utilized to determine how much data to reveal. The neuromorphic privacy core may include privacy synapses that connect privacy neurons to each other. The privacy synapses may strengthen with consistent threat signals or may weaken if a pattern is deemed safe.

The neuromorphic privacy core may leverage a spiking neural network (SNN) architecture, which mimics the operation of biological neural networks. The privacy neurons in the SNN may be designed to operate using discrete events called spikes, which represent the timing of action potentials in biological neurons. Each privacy neuron may be modeled using leaky integrate-and-fire (LIF) neurons, where the privacy neuron's membrane potential integrates incoming spikes and generates an output spike when the potential exceeds a certain threshold. The LIF model may be mathematically described using differential equations that govern the dynamics of the membrane potential.

The privacy synapses connecting the privacy neurons may include adjustable weights that determine the strengths of the connections between privacy neurons. These synaptic weights may be updated using spike-timing-dependent plasticity (STDP), a biological learning rule that adjusts the synaptic strength based on the timing of spikes. Specifically, if a presynaptic neuron's spike precedes a postsynaptic neuron's spike, the synaptic weight may be increased, whereas if the presynaptic spike follows the postsynaptic spike, the weight may be decreased. This learning mechanism may enable the neuromorphic privacy core to adapt to new patterns and threats dynamically.

To implement the neuromorphic privacy core, specialized hardware such as SNN chips or analog/digital hybrid neuromorphic chips can be used. These hardware components may be designed to efficiently simulate large-scale spiking neural networks with low power consumption. These chips may support real-time processing of neural signals and provide on-chip learning capabilities to update synaptic weights based on the STDP rule.

The memory may include a short-term memory and a long-term memory. The short-term memory may include a volatile store that captures ephemeral session data or immediate threat patterns. The short-term memory may include an in-memory data store (e.g., Redis), time-to-live (TTL)-based expiration, configurable retention periods, and memory sectors (e.g., for session patterns, temporary blocks, challenge responses, and rate limiting counters). The long-term memory may persist recognized patterns and may enable the security system 110 to adapt over days/weeks, forming more stable privacy rules. The long-term memory may include a distributed database, a time-series data store, compression for historical data, and a partitioning strategy (e.g., by service type, by threat level, and/or by geographic region).

The data structure 115 may store data from a telecommunications provider, private data from agencies, and/or the like. The data structure 115 may store data in an encrypted format, such as a homomorphic encryption (HE) format (e.g., a form of encryption that allows computations to be carried out on ciphertext, generating an encrypted result that, when decrypted, matches the result of operations performed on the plaintext and enables secure data processing without exposing the underlying data), a functional encryption format (e.g., a cryptographic approach that allows decrypting only specific “functions” of the data rather than full plain text), and/or the like. In some implementations, the data structure 115 may receive sensitive data from a telecommunications provider, an agency, and/or the like. The data structure 115 may encrypt the data with a key management service. All keys may remain under enterprise control, and users never handle keys that can directly decrypt the data. The data structure 115 may anonymize or tokenize sensitive fields of the stored data. This may mitigate security risks in case of accidental leakage of data. In some implementations, the data structure 115 may utilize zero knowledge proofs (ZKPs) for certain scenarios to verify statements about data without revealing the data. For example, a user may prove that the user is located in a certain region without revealing the user's exact location. For analytics use cases (e.g., aggregated queries), the data structure 115 may apply differential privacy noise so that results do not reveal details of individuals in the dataset. The data structure 115 may provide, to the secure platform, only the encrypted data necessary for execution of a function or calculation of analytics.

In some implementations, the data structure 115 may provide advanced data management. For example, the data structure 115 may provide a Redis cache for sub-millisecond fraud pattern matching, a time series database for pattern analysis and anomaly detection, a graph database for relationship analysis and fraud ring detection, and a key-value store for rapid customer profile lookup. Alternatively, or additionally, the data structure 115 may provide a smart caching strategy. For example, the data structure 115 may provide a hot cache (e.g., a last twenty-four hours of fraud patterns), a warm cache (e.g., thirty days of customer behavior profiles), and a cold storage (e.g., historical data for training and analysis).

Additionally, the data structure 115 may provide advanced data management capabilities. For instance, the data structure 115 may utilize a Redis cache for sub-millisecond fraud pattern matching, a time-series database for pattern analysis and anomaly detection, a graph database for relationship analysis and fraud ring detection, and a key-value store for rapid customer profile lookup. This advanced data management framework may ensure efficient and secure handling of various data types and access patterns, enhancing the overall performance and security of the security system 110.

As further shown in FIG. 1A, and by reference number 120, the security system 110 may receive, from the user device 105, a request to access data. For example, the user may cause the user device 105 to generate the request to access data. The user device 105 may provide the request to access data to the security system 110. The request to access data may specify the data that the user of the user device 105 wishes to access.

In one example, the request to access data may include a location retrieval API request with high-level location data (e.g., which may require a moderate trust rating, such as a secure user device and a local user), precise global positioning system (GPS) data (e.g., which may require a higher trust rating, such as a recognized user device with the user's explicit consent within a specific time window), and/or the like. In another example, the request to access data may include a know your customer (KYC) fill-in API request or a KYC match API request. In such an example, if the user device 105 is unpatched or flagged as risky, the trust rating may be too low to reveal personal data, so only partial, masked information may be provided. If the user device 105 is secure, a user subscription is premium, and a location is consistent with user records, the trust rating may be high enough to release additional KYC fields. In still another example, the request to access data may include a SIM swap API request. In such an example, a telecommunications provider may demand a high trust rating, ensuring that the request is truly from an intended financial institution. If the user's location or the user device 105 is suspicious (e.g., a request coming from an overseas network address never before used), the trust rating may be insufficient for a full SIM swap check. In another example, the request to access data may include a carrier billing/refund API request. In such an example, for small transactions, a lower trust rating may suffice. For high-value refunds, a higher trust rating or a multi-factor check may be triggered.

As shown in FIG. 1B, and by reference number 125, the security system 110 may convert the request into one or more neural signals. For example, the security system 110 may encode fields of the request to access data into one or more spiking patterns or one or more analog neural signals. The neural interface of the security system 110 may translate discrete, text-based or numeric-based information of the request into a spike-based representation or an analog neural signal that the neuromorphic core processes to produce privacy actions. In some implementations, the neural interface may convert fields of the request, such as a user device identifier, a location zone, and a time period, into corresponding neural signals. For example, the user device identifier may be encoded into a certain address space, the location zone may be encoded into a feature channel, and the time period may be encoded into a temporal pattern. This encoding may involve techniques such as spike latency encoding, firing rate encoding, temporal pattern encoding, and/or the like.

As shown in FIG. 1C, and by reference number 130, the security system 110 may process the one or more neural signals, with privacy neurons and privacy synapses, to generate aggregated outputs. For example, the security system 110 may utilize the neuromorphic privacy core to process the one or more neural signals. The neuromorphic privacy core may include privacy neurons, such as pattern neurons, threat neurons, and trust neurons, each dedicated to analyzing specific implementations of privacy-related decisions. The neuromorphic privacy core may also include privacy synapses that dynamically modulate data flow and decision weighting based on real-time feedback, strengthening or weakening connections based on learned experiences of the security system 110. In some implementations, the pattern neurons may recognize usage patterns that could raise or lower suspicion, the threat neurons may identify potential security incidents or anomalies, and the trust neurons may provide a dynamic measure of the trust of the security system 110 in the request. This processing by the privacy neurons may generate the aggregated outputs, which the security system 110 may utilize to determine subsequent actions for the request. Additionally, or alternatively, the privacy neurons and the privacy synapses may work together to modulate data flow dynamically. For example, the privacy synapses may adjust their connections based on real-time feedback, thereby optimizing a response of the security system 110 to new data.

Additionally, or alternatively, the security system 110 may utilize a machine learning model within the neuromorphic privacy core to enhance decision-making capabilities and to ensure more accurate identification of privacy threats and adjustments to data flow. The machine learning model may continually learn from new data to improve threat detection accuracy. Additionally, or alternatively, dynamic feedback mechanisms within the neuromorphic privacy core may ensure that the security system 110 continuously adapts to changing usage patterns and newly identified threats, thereby maintaining robust privacy protection. For example, if a new type of threat is detected, the feedback mechanism may adjust parameters of the security system 110 to counteract the threat effectively. Additionally, or alternatively, the neuromorphic privacy core may include additional neurons for specialized tasks, such as a compliance neuron for regulatory checks or an anomaly detection neuron for determining unusual activity. These specialized neurons may ensure that the security system 110 can handle various privacy-related scenarios comprehensively. Additionally, or alternatively, the neuromorphic privacy core may operate in conjunction with other security systems to provide a multi-layered approach to data privacy and to integrate seamlessly with existing protocols and data governance frameworks. This integration may ensure comprehensive protection across different systems and platforms.

The aggregated outputs generated by the neuromorphic privacy core may include results or conclusions derived from processing the neural signals through the privacy neurons and privacy synapses. The aggregated outputs may include detection of a privacy threat, ephemeral data usage, stable pattern data, anomaly detection, and/or the like. If the security system 110 identifies a pattern of repeated access attempts from an unrecognized user device or location, which is inconsistent with the user's typical behavior, the aggregated output may indicate a high likelihood of a privacy threat. If the security system 110 detects a one-time access request for specific data that does not match any long-term patterns but also does not raise immediate suspicion, the aggregated output may indicate that this is ephemeral data usage. If the security system 110 recognizes a consistent pattern of data access requests that align with the user's historical behavior, such as regular logins from the same user device and location, the aggregated output may indicate that this is stable pattern data. If the security system 110 identifies an unusual pattern of behavior, such as access requests at odd hours or from multiple locations within a short time frame, which deviates from the user's normal behavior, the aggregated output may indicate that this is an anomaly to be investigated.

As shown in FIG. 1D, and by reference number 135, the security system 110 may determine whether the aggregated outputs are associated with a privacy threat, ephemeral usage data, or stable pattern data. For example, the security system 110 may analyze the aggregated outputs, and may identify an association of the aggregated outputs with different categories based on the analysis. In some implementations, the security system 110 may evaluate the aggregated outputs to determine if the aggregated outputs indicate a potential privacy threat, signify ephemeral usage (e.g., temporary data usage patterns), correspond to stable pattern data (e.g., long-term consistent data usage patterns), and/or the like. This determination may enable the security system 110 to dynamically manage data privacy and security by categorizing and responding to different types of data usage patterns. In some implementations, the security system 110 may determine whether the aggregated outputs are associated with a privacy threat, ephemeral usage data, or stable pattern data by classifying the aggregated outputs into categories such as privacy threats, ephemeral usage data, or stable pattern data based on an analysis of the neural signals processed by the privacy neurons and the privacy synapses. For example, the privacy neurons may include pattern neurons, threat neurons, and trust neurons that work together to classify the neural signals.

As shown in FIG. 1E, and by reference number 140, the security system 110 may trigger a privacy action for the request and the data based on determining that the aggregated outputs are associated with a privacy threat. For example, when the security system 110 determines that the aggregated outputs indicate a high likelihood of a privacy threat, the security system 110 may trigger a privacy action for the request and the data, such as data masking, threat mitigation, trust adjustment, and/or the like. Data masking may include the security system 110 obscuring sensitive data (e.g., personally identifiable information) to prevent unauthorized access and to generated masked data. The security system 110 may respond to the request with the masked data. Threat mitigation may include blocking the suspicious activity, and may cause the security system 110 to deny the request to access data. Trust adjustment may include the security system 110 altering a trust level assigned to the requestor, which may limit access of the user and the user device 105 to sensitive data.

As further shown in FIG. 1E, and by reference number 145, the security system 110 may store the ephemeral usage data in short-term memory and the stable pattern data in long-term memory based on determining that the aggregated outputs are not associated with a privacy threat. For example, if the aggregated outputs indicate that the data usage is ephemeral without indicating any privacy threat, the security system 110 may store the ephemeral usage data in the short-term memory for immediate decisions. Alternatively, if the aggregated outputs indicate that the data usage follows a stable pattern without indicating any privacy threat, the security system 110 may store the stable pattern data in the long-term memory for ongoing adaptation. This storage approach may enable the security system 110 to efficiently manage and utilize memory resources while ensuring that privacy threats are promptly addressed and stable data usage patterns are preserved for future reference.

FIG. 1F depicts an example of the security system 110 providing a dynamic privacy perimeter with adaptive trust zones for secure and real-time API data protection. As shown, the security system 110 may include multiple trust zones. A first trust zone (Trust zone 0—External) includes a dynamic API gateway, a load balancer, and an application firewall. The API gateway may include the features of the gateway described above in connection with FIG. 1A. The load balancer may balance requests for data received from external users. The application firewall may include a firewall that implements a firewall policy for preventing malicious requests. The first trust zone may be a first point of contact for external data requests, and may route the requests to a second trust zone (Trust zone 1—Trust) for trust and risk evaluation.

The second trust zone may include a trust management system and a risk management system. The trust management may calculate a trust score or classification (e.g., low, medium, or high) for a request, and may process the trust score, with a machine learning analysis engine, to generate a pattern. The trust management system may process the pattern, with a request pattern analyzer, to generate a pattern type. The trust management system may include a trust budget calculator that calculates a trust budget for the request based on the pattern type. The risk analysis system may analyze real-time risk factors (e.g., network address reputation, request frequency, user device fingerprint, and/or the like). The risk analysis system may utilize a real-time threat scanner to identify request frequency, an Internet protocol intelligence component to identify the network address reputation, and a device analyzer to identify the user device fingerprint. The risk analysis system may include an adaptive behavior analysis machine learning model that detects anomalies in usage patterns based on the real-time risk factors, and that dynamically raises or lowers trust associated with the user and/or the user device 105.

A third trust zone (Trust zone 2—Privacy) may include a privacy control system and a data masking system. The privacy control system may include a privacy budget manager that allocates how much privacy budget is permissible for the request based on the trust score (e.g., a higher trust score may equate to more data detail). The privacy control system may include a privacy enforcer that enforces the privacy budget allocated by the privacy budge manager, and a privacy meter that calculates how much of the privacy budget has been utilized by a request. The privacy control system may include a privacy auditor that stores privacy budgets and utilizations of the privacy budgets. The data masking system may include a noise generator that generates noise to conceal data, and a pattern scrambler that scrambles the data. The data masking system may include a time dithering component that utilizes time dithering to mask data, and a signal cloaker that cloaks data.

A fourth trust zone (Trust zone 3—Core services) may include the data structure 115 and a secure processing component. The data structure 115 may include the features described above in connection with FIG. 1A. In some implementations, the data structure 115 may include a key vault, a data vault, and a temporary vault. The secure processing component may include a trusted execution environment (TEE), a zero-knowledge proof (ZKP) generator, and a homomorphic engine. The TEE may provide a secure and trusted execution environment, such as, for example, Intel software guard extensions (SGX), AMD secure encrypted visualization (SEV), and Amazon web services (AWS) Nitro enclave environments. The TEE may provide isolated, hardware-level secure regions in which code and data remain protected—even from a host operating system. In some implementations, the TEE may provide a privacy-preserving framework, such as an Oasis Labs framework, a conclave (R3) framework, or a confidential consortium framework. The ZKP generator may provide proofs for data correctness or identify checks without exposing sensitive data. The homomorphic engine may enable computations on encrypted data without revealing plaintext.

As shown in FIG. 1G, and by reference number 150, the security system 110 may receive, from the user device 105, another request to access other data. For example, the user may cause the user device 105 to generate the other request to access the other data. The user device 105 may provide the other request to access the other data to the security system 110. The other request to access the other data may specify the other data that the user of the user device 105 wishes to access.

In one example, the other request to access the other data may include a location retrieval API request with high-level location data (e.g., which may require a moderate trust rating, such as a secure user device and a local user), precise GPS data (e.g., which may require a higher trust rating, such as a recognized user device with the user's explicit consent within a specific time window), and/or the like. In another example, the other request to access the other data may include a KYC fill-in API request or a KYC match API request. In such an example, if the user device 105 is unpatched or flagged as risky, the trust rating may be too low to reveal personal data, so only partial, masked information may be provided. If the user device 105 is secure, a user subscription is premium, and a location is consistent with user records, the trust rating may be high enough to release additional KYC fields. In still another example, the other request to access the other data may include a SIM swap API request. In such an example, a telecommunications provider may demand a high trust rating, ensuring that the request is truly from an intended financial institution. If the user's location or the user device 105 is suspicious (e.g., a request coming from an overseas network address never before used), the trust rating may be insufficient for a full SIM swap check. In another example, the other request to access the other data may include a carrier billing/refund API request. In such an example, for small transactions, a lower trust rating may suffice. For high-value refunds, a higher trust rating or a multi-factor check may be triggered.

As further shown in FIG. 1G, and by reference number 155, the security system 110 may determine a real-time risk associated with the other request and may calculate a trust score based on the real-time risk. For example, the security system 110 may analyze various factors, such as the network address reputation, the request frequency, and the user device fingerprint, to evaluate the real-time risk. In some implementations, the security system may utilize a machine learning model to analyze the various factors and to calculate the real-time risk associated with the other request. In some implementations, the security system 110 may analyze user behavior patterns to determine the real-time risk associated with the other request. For example, the security system 110 may monitor how the user typically interacts with the security system 110, such as by monitoring login times and commonly accessed resources, to identify deviations from normal behavior. Additionally, or alternatively, the security system 110 may evaluate functionality of the user device 105 and an origin of the other request to determine the real-time risk. For example, the security system 110 may assess whether the user device 105 has up-to-date security patches and may verify the geographical location from which the other request is made.

Additionally, or alternatively, the security system 110 may incorporate historical data and past interactions to determine the real-time risk. For example, the security system 110 may reference previous interactions with the same user or the user device 105 to identify patterns that could indicate a lower or higher risk. Additionally, or alternatively, the security system 110 may utilize contextual data, such as time of day and location of the other request, to determine the real-time risk. For example, a request made at an unusual time or from an unexpected location might be considered higher risk. Additionally, or alternatively, the security system 110 may integrate data from external threat intelligence sources to enhance the accuracy of the determination of the real-time risk. For example, the security system 110 may use information about recent cyber threats to adjust the real-time risk.

The security system 110 may calculate the trust score for the other request based on the real-time risk for the other request. In some implementations, the security system 110 may utilize a machine learning model to generate the trust score that reflects the trustworthiness of the other request. In some implementations, the trust score may indicate a likelihood of the other request being legitimate or malicious. For example, if the other request frequency is unusually high or the network address has a poor reputation, the trust score may be lower, indicating a higher risk. Conversely, if the other request is consistent with known behavior patterns and originates from a recognized user device 105, the trust score may be higher, indicating a lower risk.

Additionally, or alternatively, the security system 110 may apply an adaptive learning model to continuously update the trust score based on evolving request patterns and detected anomalies. For example, the security system 110 may adjust risk assessment models as it learns from new behaviors and threats. Additionally, or alternatively, the security system 110 may utilize weighted scoring that considers multiple risk factors, such as the network address reputation, user device fingerprint, and request frequency, to calculate the trust score. For example, each risk factor may be assigned a specific weight to reflect a relative importance in the overall risk assessment. Additionally, or alternatively, the security system 110 may implement a multi-layered trust evaluation process that dynamically adjusts the trust score as new risk factors are detected. For example, the initial trust score may be adjusted if new information becomes available during the request processing. Additionally, or alternatively, the security system 110 may employ privacy-preserving techniques, such as differential privacy, to securely analyze risk factors and calculate a trust score without compromising sensitive data. For example, the security system 110 may ensure that sensitive data is not exposed during the risk assessment and trust score calculation processes.

Additionally, or alternatively, the security system 110 may generate alerts or trigger additional verification steps if the calculated trust score falls below a predefined threshold, indicating potential malicious activity. For example, the security system 110 may require additional authentication from the user or temporarily block the other request until the other request can be verified.

As shown in FIG. 1H, and by reference number 160, the security system 110 may determine whether the trust score satisfies a first threshold. For example, the security system 110 may compare the trust score and the first threshold, and may determine whether the trust score satisfies the first threshold for accessing the other data based on comparing the trust score and the first threshold. In some implementations, the security system 110 may utilize a machine learning model to determine whether the trust score satisfies (e.g., meets or exceeds) the predefined first threshold for allowing access to the requested other data. In some implementations, the security system 110 may determine that the trust score satisfies the first threshold. Alternatively, the security system 110 may determine that the trust score fails to satisfy the first threshold.

As further shown in FIG. 1H, and by reference number 165, the security system 110 may prevent access to the other data based on the trust score failing to satisfy the first threshold. For example, if the security system 110 determines that the trust score fails to satisfy (e.g., is below) the first threshold, indicating a higher risk or potential for unauthorized access, the security system 110 may deny the other request to access the other data. This preventive action may ensure that sensitive data (e.g., in the data structure 115) remains protected from potentially malicious or untrusted requests. The security system 110 may provide, to the user device 105, a notification indicating that the other request is denied. In some implementations, preventing access to the other data may include blocking the other request to access the other data. For example, if the trust score indicates a potentially compromised account for the user device 105, the security system 110 may block requests from the user device 105.

As shown in FIG. 1I, and by reference number 170, the security system 110 may determine whether the trust score satisfies a second threshold based on determining that the trust score satisfies the first threshold. For example, if the security system 110 determines that the trust score satisfies the first threshold, the security system 110 may compare the trust score and the second threshold (e.g., that is less than the first threshold), and may determine whether the trust score satisfies the second threshold for accessing the other data based on comparing the trust score and the second threshold. In some implementations, the security system 110 may utilize a machine learning model to determine whether the trust score satisfies (e.g., meets or exceeds) the predefined second threshold for allowing access to the requested other data. In some implementations, the security system 110 may determine that the trust score satisfies the second threshold. Alternatively, the security system 110 may determine that the trust score fails to satisfy the second threshold.

As further shown in FIG. 1I, and by reference number 175, the security system 110 may obscure the other data based on the trust score failing to satisfy the second threshold and may provide the obscured other data to the user device 105. For example, if the security system 110 determines that the trust score fails to satisfy the second threshold, the security system 110 may retrieve the other data from the data structure 115, and may obscure (e.g., mask) sensitive data in the other data to generate the obscured other data. The security system 110 may provide the obscured other data to the user device 105, and the user device 105 may present the obscured other data to the user.

As further shown in FIG. 1I, and by reference number 180, the security system 110 may provide the other data to the user device 105 based on the trust score satisfying the second threshold. For example, if the security system 110 determines that the trust score satisfies the second threshold, the security system 110 may retrieve the other data from the data structure 115, and may provide the other data to the user device 105. The user device 105 may then present the other data to the user.

In this way, the security system 110 provides neuromorphic privacy learning and a dynamic privacy perimeter. For example, the security system 110 replaces static and inflexible security measures of current systems with a neuromorphic approach that dynamically assesses and responds to privacy risks in real-time. The neuromorphic approach may enable the security system 110 to prevent the need for extensive rule-based processing and manual updates in response to new security threats. In addition, the security system 110 may provide for efficient memory usage by separating specialized neurons and synapses for different privacy tasks, thus reducing redundant data processing. The security system 110 may dynamically modulate data flow and decision weighting, which may enhance the security framework, streamline data exchanges, and minimize unnecessary data transmissions. Thus, the security system 110 may conserve computing resources, networking resources, and/or other resources that would have otherwise been consumed by failing to adapt to changing security threats over time, failing to adjust to changing trust levels or risk factors associated with each data request, handling privacy breaches caused by failing to adapt to changing security threats, trust levels, or risk factors, handling unauthorized data access caused by failing to adapt to changing security threats, trust levels, or risk factors, and/or the like.

As indicated above, FIGS. 1A-1I are provided as an example. Other examples may differ from what is described with regard to FIGS. 1A-1I. The number and arrangement of devices shown in FIGS. 1A-1I are provided as an example. In practice, there may be additional devices, fewer devices, different devices, or differently arranged devices than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) shown in FIGS. 1A-1I may perform one or more functions described as being performed by another set of devices shown in FIGS. 1A-1I.

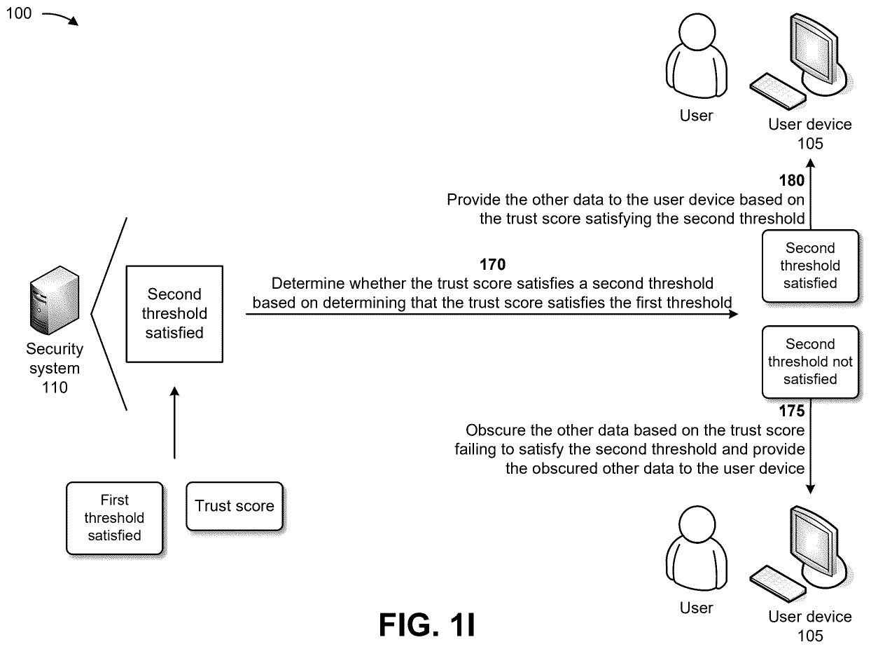

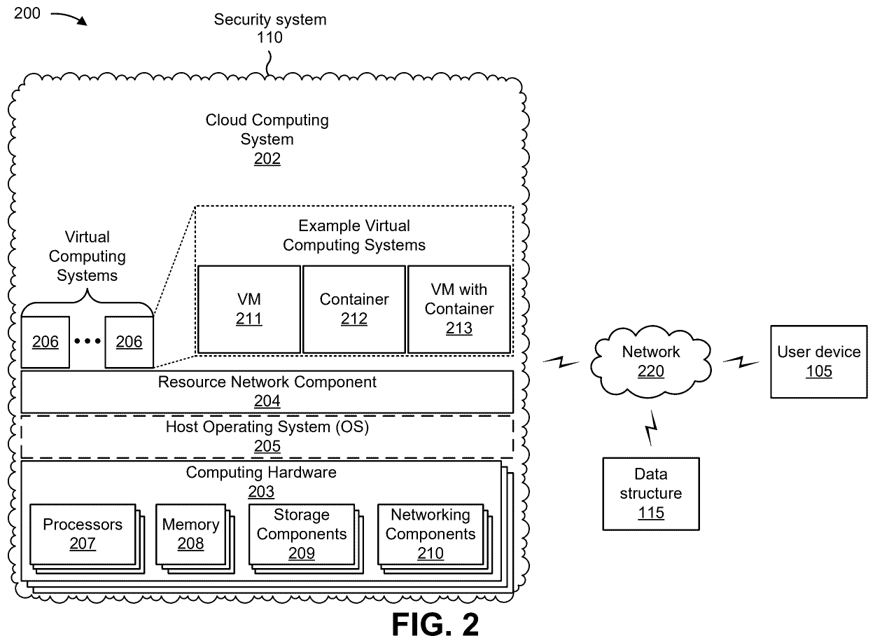

FIG. 2 is a diagram of an example environment 200 in which systems and/or methods described herein may be implemented. As shown in FIG. 2, the environment 200 may include the security system 110, which may include one or more elements of and/or may execute within a cloud computing system 202. The cloud computing system 202 may include one or more elements 203-213, as described in more detail below. As further shown in FIG. 2, the environment 200 may include the user device 105, the data structure 115, and/or a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The data structure 115 may include one or more devices capable of receiving, generating, storing, processing, and/or providing information, as described elsewhere herein. The data structure 115 may include a communication device and/or a computing device. For example, the data structure 115 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 115 may communicate with one or more other devices of the environment 200, as described elsewhere herein.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

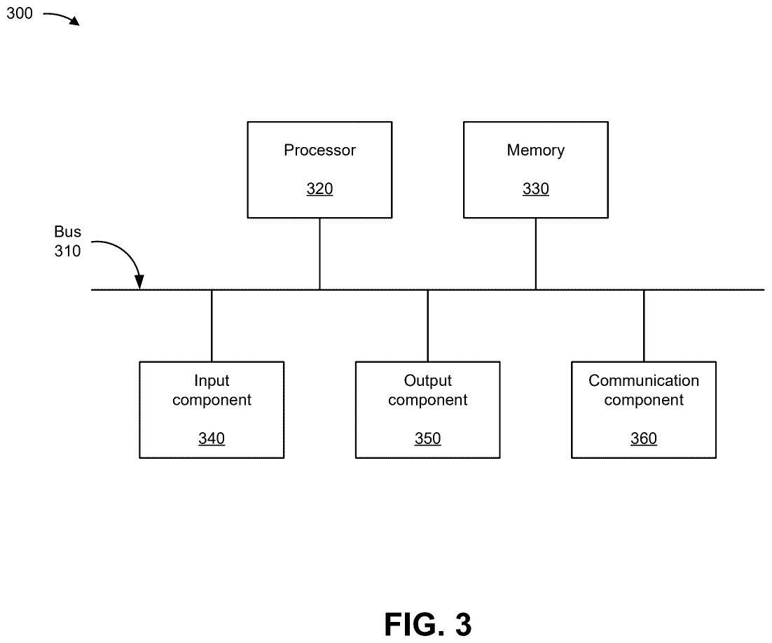

Although the security system 110 may include one or more elements 203-213 of the cloud computing system 202, may execute within the cloud computing system 202, and/or may be hosted within the cloud computing system 202, in some implementations, the security system 110 may not be cloud-based (e.g., may be implemented outside of a cloud computing system) or may be partially cloud-based. For example, the security system 110 may include one or more devices that are not part of the cloud computing system 202, such as a device 300 of FIG. 3, which may include a standalone server or another type of computing device. The security system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200. In some implementations, the network 220 includes a network capable of providing network slices, such as a 5G core network.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105, the security system 110, and/or the data structure 115. In some implementations, the user device 105, the security system 110, and/or the data structure 115 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

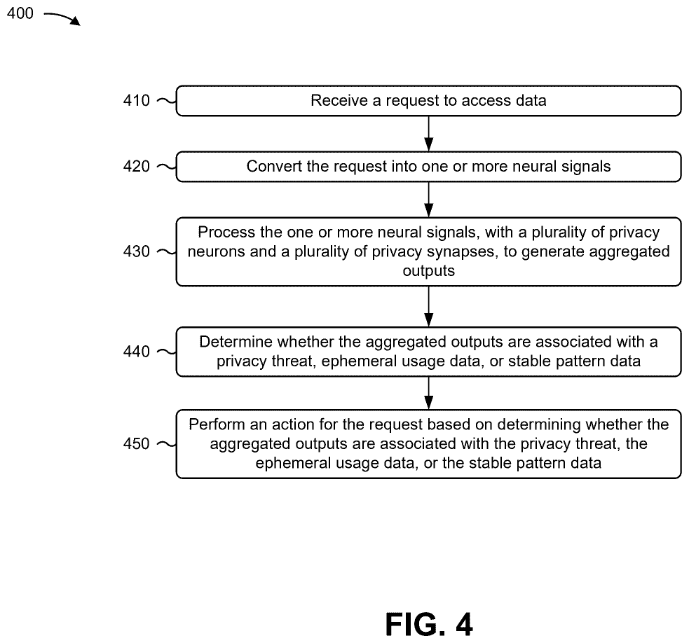

FIG. 4 depicts a flowchart of an example process 400 for providing neuromorphic privacy learning and a dynamic privacy perimeter. In some implementations, one or more process blocks of FIG. 4 may be performed by a device (e.g., the security system 110). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a request to access data (block 410). For example, the device may receive a request to access data, as described above.

As further shown in FIG. 4, process 400 may include converting the request into one or more neural signals (block 420). For example, the device may convert the request into one or more neural signals, as described above. In some implementations, converting the request into the one or more neural signals includes encoding fields of the request into one or more spiking patterns or one or more analog neural signals.

As further shown in FIG. 4, process 400 may include processing the one or more neural signals, with a plurality of privacy neurons and a plurality of privacy synapses, to generate aggregated outputs (block 430). For example, the device may process the one or more neural signals, with a plurality of privacy neurons and a plurality of privacy synapses, to generate aggregated outputs, as described above. In some implementations, the plurality of privacy neurons includes pattern neurons, threat neurons, and trust neurons, and the plurality of privacy synapses dynamically modulate data flow and decision weighting based on real-time feedback.

As further shown in FIG. 4, process 400 may include determining whether the aggregated outputs are associated with a privacy threat, ephemeral usage data, or stable pattern data (block 440). For example, the device may determine whether the aggregated outputs are associated with a privacy threat, ephemeral usage data, or stable pattern data, as described above.

As further shown in FIG. 4, process 400 may include performing an action for the request based on determining whether the aggregated outputs are associated with the privacy threat, the ephemeral usage data, or the stable pattern data (block 450). For example, the device may perform an action for the request based on determining whether the aggregated outputs are associated with the privacy threat, the ephemeral usage data, or the stable pattern data, as described above. In some implementations, performing the action for the request includes triggering a privacy action for the request based on determining that the aggregated outputs are associated with the privacy threat. In some implementations, the privacy action includes one or more of data masking, threat mitigation, or a trust adjustment.

In some implementations, performing the action for the request includes storing the ephemeral usage data in short-term memory based on determining that the aggregated outputs are associated with the ephemeral usage data. In some implementations, performing the action for the request includes storing the stable pattern data in long-term memory based on determining that the aggregated outputs are associated with the stable pattern data.

In some implementations, process 400 includes updating the plurality of privacy synapses based on newly detected threats or changing usage patterns. In some implementations, process 400 includes receiving, from a user device, another request to access other data, determining a real-time risk associated with the other request, calculating a trust score based on the real-time risk, and determining whether the trust score satisfies a first threshold. In some implementations, process 400 includes preventing access of the user device to the other data based on the trust score failing to satisfy the first threshold.

In some implementations, process 400 includes determining whether the trust score satisfies a second threshold based on determining that the trust score satisfies the first threshold.

In some implementations, process 400 includes obscuring the other data to generate obscured other data based on the trust score failing to satisfy the second threshold, and providing the obscured other data to the user device. In some implementations, process 400 includes providing the other data to the user device based on the trust score satisfying the second threshold.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a request to access data;
converting, by the device, the request into one or more neural signals;
processing, by the device, the one or more neural signals, with a plurality of privacy neurons and a plurality of privacy synapses, to generate aggregated outputs;
determining, by the device, whether the aggregated outputs are associated with a privacy threat, ephemeral usage data, or stable pattern data; and
performing, by the device, an action for the request based on determining whether the aggregated outputs are associated with the privacy threat, the ephemeral usage data, or the stable pattern data.

2. The method of claim 1, wherein performing the action for the request comprises:
triggering a privacy action for the request based on determining that the aggregated outputs are associated with the privacy threat.

3. The method of claim 2, wherein the privacy action includes one or more of data masking, threat mitigation, or a trust adjustment.

4. The method of claim 1, wherein performing the action for the request comprises: storing the ephemeral usage data in short-term memory based on determining that the aggregated outputs are associated with the ephemeral usage data.

5. The method of claim 1, wherein performing the action for the request comprises: storing the stable pattern data in long-term memory based on determining that the aggregated outputs are associated with the stable pattern data.

6. The method of claim 1, wherein the plurality of privacy neurons include pattern neurons, threat neurons, and trust neurons, and the plurality of privacy synapses dynamically modulate data flow and decision weighting based on real-time feedback.

7. The method of claim 1, further comprising:
updating the plurality of privacy synapses based on newly detected threats or changing usage patterns.

8. A device, comprising:
one or more processors configured to:
receive a request to access data;
convert the request into one or more neural signals;
process the one or more neural signals, with a plurality of privacy neurons and a plurality of privacy synapses, to generate aggregated outputs,
wherein the plurality of privacy neurons include pattern neurons, threat neurons, and trust neurons, and the plurality of privacy synapses dynamically modulate data flow and decision weighting based on real-time feedback;
determine whether the aggregated outputs are associated with a privacy threat, ephemeral usage data, or stable pattern data; and
perform an action for the request based on determining whether the aggregated outputs are associated with the privacy threat, the ephemeral usage data, or the stable pattern data.

9. The device of claim 8, wherein the one or more processors, to convert the request into the one or more neural signals, are configured to:
encode fields of the request into one or more spiking patterns or one or more analog neural signals.

10. The device of claim 8, wherein the one or more processors are further configured to:
receive, from a user device, another request to access other data;
determine a real-time risk associated with the other request;
calculate a trust score based on the real-time risk; and
determine whether the trust score satisfies a first threshold.

11. The device of claim 10, wherein the one or more processors are further configured to:
prevent access of the user device to the other data based on the trust score failing to satisfy the first threshold.

12. The device of claim 10, wherein the one or more processors are further configured to:
determine whether the trust score satisfies a second threshold based on determining that the trust score satisfies the first threshold.

13. The device of claim 12, wherein the one or more processors are further configured to:
obscure the other data to generate obscured other data based on the trust score failing to satisfy the second threshold; and
provide the obscured other data to the user device.

14. The device of claim 12, wherein the one or more processors are further configured to:
provide the other data to the user device based on the trust score satisfying the second threshold.

15. A non-transitory computer-readable medium storing a set of instructions, the set of instructions comprising:
one or more instructions that, when executed by one or more processors of a device, cause the device to:
receive a request to access data;
convert the request into one or more neural signals;
process the one or more neural signals, with a plurality of privacy neurons and a plurality of privacy synapses, to generate aggregated outputs;
determine whether the aggregated outputs are associated with a privacy threat, ephemeral usage data, or stable pattern data;
perform an action for the request based on determining whether the aggregated outputs are associated with the privacy threat, the ephemeral usage data, or the stable pattern data; and
update the plurality of privacy synapses based on newly detected threats or changing usage patterns.

16. The non-transitory computer-readable medium of claim 15, wherein the one or more instructions, that cause the device to perform the action for the request, cause the device to selectively:
trigger a privacy action for the request based on determining that the aggregated outputs are associated with the privacy threat;
store the ephemeral usage data in short-term memory based on determining that the aggregated outputs are associated with the ephemeral usage data; or
store the stable pattern data in long-term memory based on determining that the aggregated outputs are associated with the stable pattern data.

17. The non-transitory computer-readable medium of claim 15, wherein the one or more instructions, that cause the device to convert the request into the one or more neural signals, cause the device to:
encode fields of the request into one or more spiking patterns or one or more analog neural signals.

18. The non-transitory computer-readable medium of claim 15, wherein the one or more instructions further cause the device to:
receive, from a user device, another request to access other data;
determine a real-time risk associated with the other request;
calculate a trust score based on the real-time risk;
determine whether the trust score satisfies a first threshold; and
selectively:
prevent access of the user device to the other data based on the trust score failing to satisfy the first threshold, or
determine whether the trust score satisfies a second threshold based on determining that the trust score satisfies the first threshold.

19. The non-transitory computer-readable medium of claim 18, wherein the one or more instructions further cause the device to:
obscure the other data to generate obscured other data based on the trust score failing to satisfy the second threshold; and
provide the obscured other data to the user device.

20. The non-transitory computer-readable medium of claim 18, wherein the one or more instructions further cause the device to:
provide the other data to the user device based on the trust score satisfying the second threshold.
